(19) United States
(12) Patent Application Publication
(10) Pub. No.: US 2018/0032069 A1
(43) Pub. Date: Feb. 1, 2018

(54) INTELLIGENT ONLINE FAULT DETECTION AND EARLY WARNING METHOD FOR HEATING AND VENTILATION MACHINE ROOM

(71) Applicant: Chunlei Ren, Hefei (CN)

(72) Inventor: Chunlei Ren, Hefei (CN)

(21) Appl. No.: 15/256,659

(22) Filed: Sep. 5, 2016

(30) Foreign Application Priority Data
Jul. 29, 2016 (CN) 201610613228.7

(51) Int. Cl. G05B 23/02; G05D 23/19; G08B 21/18

(52) U.S. Cl. CPC G05B 23/0283; G08B 21/187; G05D 23/1917

(57) ABSTRACT

The present invention discloses an intelligent online fault detection and early warning method for a heating and ventilation machine room. A data processing center and a data collection center are established, and various signal collection units are respectively arranged in each device part of a pipeline system and an electrical system of the heating and ventilation machine room; the data collection center collects signals collected by the signal collection unit in each device part and transmits the signals to the data processing center; and the data processing center processes the signal collected by each signal collection unit through a program and performs fault judgment and early warning. The present invention is an intelligent detection system which can realize online device detection and pre-judgment of operation conditions, a time prompt of predicting the maintenance needed by the device, online detection and judgment of water quality and a water volume of the system, and water treatment and water supplementation as needed and can upload the data to a remote client to be analyzed by virtue of software.

### CROSS-REFERENCE TO RELATED APPLICATIONS

This application claims priority benefit of Chinese Patent Application No. 201610613228.7 with a filing date of Jul. 29, 2016. The content of the aforementioned application, including any intervening amendments thereto, are incorporated herein by reference.

### TECHNICAL FIELD

The present invention relates to the field of heating and ventilation machine rooms, in particular to an intelligent online fault detection and ear y warning method for a heating and ventilation machine room.

### BACKGROUND OF THE PRESENT INVENTION

At present, a central air conditioner control system for a heating and ventilation machine room only has a simple equipment control and operation function and does not have a function for analyzing and prejudging a fault, thereby being simple in function and backward in control. With regard to the existing heating and ventilation machine room equipment, a fault can be discovered by a user only after the fault has already occurred, a device state cannot be checked in real time, and prejudgment, early warning and timely processing cannot be carried out in advance.

### SUMMARY OF PRESENT INVENTION

The present invention aims at overcoming the weaknesses of the prior art, and provides an intelligent online fault detection and early warning system for a heating and ventilation machine room, and the intelligent online fault detection and early warning system for the heating and ventilation machine room can well solve the above problems.

In order to achieve the above-mentioned objective, the present invention adopts a technical solution as follows:

An intelligent fault detection and early warning method for a heating and ventilation machine room is characterized in that: a data processing center and a data collection center are established in the heating and ventilation machine room, and various signal collection units are respectively arranged in each device part of a pipeline system and an electrical system of the heating and ventilation machine room; with regard to the pipeline system, the signal collection units collect an operation time signal and a micro vibration displacement signal of device parts in the pipeline system as well as a temperature signal, a pressure signal, a water quality signal and a water level signal of water in the device parts; and with regard to the electrical system, the signal collection units collect a voltage signal, a current signal and a temperature signal of the device parts in the electrical system.

The data collection center collects signals collected by the signal collection units in various device parts and transmits the signals to the data processing center; the data processing center processes the signals collected by various signal collection units through a program, judges an operation condition of each device part according to the signals, and predicts a future operation condition of each device part; when the data processing center judges that the device parts have a fault or predicts that the device parts would have a fault in the future, a warning signal is sent out; meanwhile, the data processing center controls an execution part in a corresponding device part to act, sends out an online and remote warning signal for a problem that cannot be processed and restored by the corresponding device part or system so as to prompt the working personnel to perform corresponding processing, and has a function for automatically protecting a system, which is not processed and restored in time or would have a major fault, against starting up.

The intelligent online fault detection and early warning method for the heating, and ventilation machine room is characterized in that: a signal collection unit for collecting an overall environment signal is also arranged in the heating and ventilation machine room, wherein the environment signal collected by the signal collection unit includes but not limited to a temperature signal and a harmful gas signal of the heating and ventilation machine room; and the data processing center controls the execution part in the corresponding device part to act according to the collected signal, or transmits a remote online and remote warning signal for the problem that cannot be automatically processed and restored by the system so as to prompt the working personnel to perform corresponding maintenance and treatment, and has a function for automatically protecting and preventing the power-on of a system which is not processed and restored in time or would have a major fault,

The intelligent online fault detection and early warning method for the heating and ventilation machine room is characterized in that: a water quality signal includes but not limited to a turbidity signal, a PH value signal, a dissolved oxygen content signal and an electric conductivity signal; and the data processing center controls an execution part in the corresponding device part to act according to the collected signal, or transmits an online and remote warning signal for the problem that cannot be automatically processed and restored by the system so as to prompt the working personnel to perform corresponding processing, and has a function for automatically protecting a system, which is not processed and restored in time or would have a major fault, against starting up.

The intelligent online fault detection and early warning method for the heating and ventilation machine room is characterized in that: signals include but not limited to a device operation time signal and a micro vibration displacement signal; and the data processing center judges whether the device parts in the pipeline system reach a maintenance phase according to the collected signal and prompts the working personnel to perform the maintenance on site, or judges a probable running vibration major accident of the device parts in the pipeline system according to the collected signal, transmits an online and remote warning signal so as to prompt the working personnel to perform corresponding processing, and has a function for automatically protecting a system, which is not processed and restored in time or would have the major fault, against starting up,

The intelligent online fault detection and early warning method for the heating and ventilation machine room is characterized in that the online and remote way is a wireless transmission mode of an Internet or cell phone terminal.

The intelligent online fault detection and early warning method for the heating and ventilation machine room is characterized in that: the data processing center is configured to transmit a result after being processed by a remote Internet data processing center or a machine room data processing center.

Compared with the prior art, the present invention has the beneficial effects as follows:

(1) the operation condition of the device can be checked on line in real time or remotely, thereby controlling the condition information of the system at first time;

(2) the operation information in the system can be analyzed and detected in real time, and whether the water quality treatment or constant-pressure water supplementing is needed or not is automatically judged; and

(3) the determination is carried out according to various; collected information, and online or remote warning information can be sent out in real time for the faults and problems which cannot be processed by the system and would occur, thereby prompting the working personnel to perform the processing in time.

### DESCRIPTION OF THE DRAWINGS

FIG. 1 is a principle block diagram of specific embodiments of the present invention.

### DETAILED DESCRIPTION OF PREFERRED EMBODIMENTS

An intelligent online fault detection and early warning method for a heating and ventilation machine room is disclosed; a data processing center and a data collection center are established in the heating and ventilation machine room, and various signal collection units are respectively arranged in each device part of a pipeline system and an electrical system of the heating and ventilation machine room; with regard to the pipeline system, the signal collection units collect an operation time signal and a micro vibration displacement signal of the device parts in the pipeline system as well as a temperature signal, a pressure signal, a water quality signal and a water level signal of water in the device parts; and with regard to the electrical system, the signal collection units collect a voltage signal, a current signal and a temperature signal of the device parts in the electrical system.

The data collection center collects signals collected by the signal collection units in various device parts and transmits the signals to the data processing center; the data processing center processes the signals collected by various signal collection units through a program, judges an operation condition of each device part according to the signals, and predicts a future operation condition of each device part; when the data processing center judges that the device parts have a fault or predicts that the device parts would have a fault in the future, a warning signal is issued; meanwhile, the data processing center controls an execution part in a corresponding device part to act, transmits an online and remote warning signal for a problem that cannot be processed and restored by the corresponding device part or system so as to prompt the working personnel to perform corresponding processing, and has a function for automatically protecting a system, which is not processed and restored in time or would have a major fault, against starting up

A signal collection unit for collecting an overall environment signal is also arranged in the heating and ventilation machine room, wherein the environment signal collected by the signal collection unit includes but not limited to an overall temperature signal and a harmful gas signal of the heating and ventilation machine room; and the data processing center controls an execution part in the corresponding device part to act according to the collected signal, or transmits a remote online and remote warning signal for the problem that cannot be automatically processed and restored by the system so as to prompt the working personnel to perform corresponding maintenance and processing, and has a function for automatically protecting a system, which is not processed and restored in time or would have a major fault, against starting up.

A water quality signal includes but not limited to a turbidity signal, a PH value signal, a dissolved oxygen content signal and an electric conductivity signal; and the data processing center controls an execution part in the corresponding device part to act according to the collected signal, or transmits an online and remote warning signal for the problem that cannot be automatically processed and restored by the system so as to prompt the working personnel to perform corresponding processing, and has a function for automatically protecting a system, which is not processed and restored in time or would have a major fault, against starting up,

Signals include but not limited to a device operation time signal and a micro vibration displacement signal and the data processing center judges whether the device parts in the pipeline system reach a maintenance phase according to the collected signal and prompts the working personnel to perform the maintenance on site, or determines a probable running vibration major fault situation of the device parts in the pipeline system according to the collected signal, transmits an online and remote warning, signal so as to prompt the working personnel to perform corresponding processing, and has a function for automatically protecting and preventing a system, which is not processed and restored in time or would have the major fault, against starting up.

An online and remote way is a wireless transmission mode of an Internet or cell phone terminal.

The data processing center is configured to transmit a result after being processed by a remote Internet data processing center or a machine room data processing center.

### Specific Embodiments

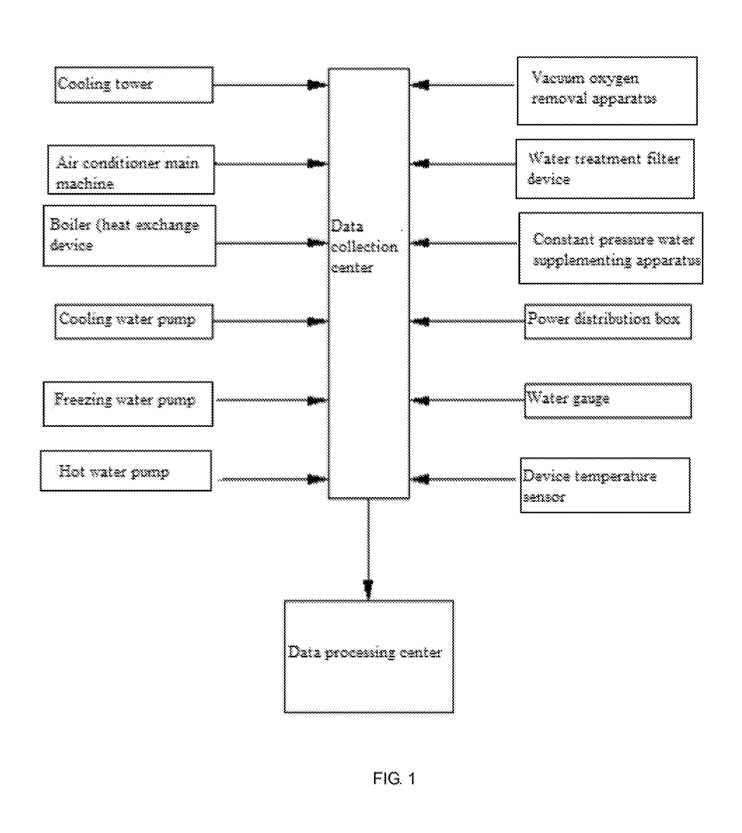

As shown in FIG. 1, a data processing center and a data collection center are established in a heating and ventilation machine room, and signal collection units are respectively arranged in a cooling tower, an air conditioner main machine, a boiler or heat exchange device, a cooling water pump, a freezing water pump, a hot water pump, a vacuum oxygen removal apparatus, a water treatment filter device, a constant-pressure water supplementing apparatus and a power distribution box of the heating and ventilation machine room, wherein the signal collection unit in the cooling tower collects a device operation time signal of the cooling tower, a water level signal in the cooling tower, a device micro vibration displacement signal, an inlet and outlet cooling water temperature signal, a pressure signal, a motor temperature signal, a current signal, a voltage signal, a circulating water turbidity signal, a PH value signal and a dissolved oxygen content signal; the signal collection unit in the air conditioner main machine collects a device operation time signal, a device micro vibration displacement, a inlet and outlet freezing water temperature signal, a pressure signal, a motor temperature signal, a current signal, a voltage signal, a freezing oil temperature signal, a circulating water turbidity signal, a PH value signal and a dissolved oxygen content signals of the air conditioner main machine; the signal collection unit in the boiler or heat exchange device collects a device operation time signal, a device micro vibration displacement signal, an inlet and outlet hot water temperature signal, a pressure signal, a motor temperature signal, a current signal, a voltage signal, a circulating water turbidity signal, a PH value signal, a dissolved oxygen content signal and a natural gas leakage rate signal of the boiler or heat exchange device; the signal collection units in the cooling water pump, the freezing water pump and the hot water pump respectively collect a device operation time signal, a device micro vibration displacement signal, an inlet and outlet water temperature signal, a pressure signal, a motor temperature signal, a current signal and a voltage signal of the cooling water pump, the freezing water pump and the hot water pump; the signal collection unit in the vacuum oxygen removal apparatus collects a device operation time signal of the vacuum oxygen removal apparatus; the signal collection unit in the water treatment filter device collects a device operation time signal of the water treatment filter device; the signal collection unit in the constant-pressure water supplementing apparatus collects a device operation time signal of the constant-pressure water supplement apparatus: and the signal collection unit in the power distribution box collects a temperature signal at a connection terminal of the power distribution box; and

output ends of the, signal collection units in the cooling tower, the air conditioner main machine, the boiler or heat exchange device, the cooling water pump, the freezing water pump, the hot water pump, the vacuum oxygen removal apparatus, the water treatment filter device, the constant-pressure water supplementing apparatus and the power distribution box are respectively connected with a signal input end of the data collection center, the signals obtained by all signal collection units are uniformly collected by the data collection center, and a signal output end of the data collection center is connected with a signal input end of the data processing center.

The intelligent online fault detection and early warning method for the heating and ventilation machine room further comprises a water gauge for detecting a water level in a water receiving tray or a water discharging trough of the heating and ventilation machine room, and an output end of the water gauge is connected with the signal input end of the data collection center.

The intelligent online fault detection and early warning method for the heating and ventilation machine room further comprises a device temperature sensor for collecting an environment temperature signal in the heating and ventilation machine room, wherein an output end of the device temperature sensor is connected with the signal input end of the data collection center.

The present invention provides a data collection center, which collects the operation condition information of the devices such as the cooling tower, the air conditioner main machine, the boiler or heat exchange device, the cooling water pump, the freezing water pump, the hot water pump, the vacuum oxygen removal apparatus, the water treatment filter device, the constant-pressure water supplementing apparatus, the power distribution box and the like and the water level information of the water gauge, and transmits the collected information to the data processing center, the information is judged by the data processing center, and the fault situation which would probably occur is analyzed, detected and judged according to the operation condition, thereby carrying out the information feedback and warning. The predicted fault is analyzed, removed and restored.

The signal collection of the cooling tower is to collect information such as cooling tower operation time, water level in the tower, device micro vibration displacement, inlet and outlet cooling water temperature, pressure, motor temperature, current, voltage, circulating water turbidity, PH value, dissolved oxygen content, and the like. The collected information is transmitted to the data processing center, and the analysis and processing are carried out according to the feedback data.

The signal collection of the air conditioner main machine is to collect information such as air conditioner main machine operation time, device micro vibration displacement, inlet and outlet freezing water temperature, pressure, motor temperature, current, voltage, freezing oil temperature, circulating water turbidity, PH value, dissolved oxygen content, and the like. The collected information is transmitted to the data processing center, and the analysis and processing are carried out according to the feedback data, thereby monitoring and pre-judging the fault, and processing the prejudged fault information in real time.

The signal collection of the boiler or heat exchange device is to collect information such as device operation time, device micro vibration displacement, inlet and outlet hot water temperature, pressure, motor temperature, current, voltage, circulating water turbidity, PH value and dissolved oxygen content, natural gas leakage rate and the like of the boiler or exchange device (heat exchange device). The collected information is transmitted to the data processing center, and the analysis and processing are carried out according to the feedback data, thereby monitoring and prejudging the fault, and processing the pre-judged fault information in real time.

The signal collection of the freezing water pump, the cooling water pump and the hot water pump is to collect information such as operation time, micro vibration displacement, inlet and outlet water temperature, pressure, motor temperature, current, voltage, and the like of the water pump device. The collected information is transmitted to the data processing center, and the analysis and processing are carried out according to the feedback data, thereby monitoring and pre-judging the fault, and processing the pre-judged fault information in real time.

The signal collection of the vacuum oxygen removal apparatus is to collect the operation time of the vacuum oxygen removal apparatus: and the collected dissolved oxygen content of the system circulating water is analyzed and judged by the data processing center, thereby providing an instruction for controlling the device to start and stop. The starting and stopping time of the device can be automatically determined according to the system operation.

The signal collection of the water treatment filter device is to collect the operation time of the water treatment filter device; and the collected information such as the turbidity, PH value and electric conductivity of the system circulating water are analyzed and judged by the data processing center, thereby providing an instruction for controlling the device to start and stop.

The signal collection of the constant-pressure water supplementing device is to collect the operation time of the constant-pressure water supplementing device; and the collected pressure information of the system circulating water is analyzed and judged by the data processing center, thereby providing an instruction for controlling the device to start and stop.

The water gauge is disposed in the water receiving tray or the water discharging trough and detects a water level signal in the receiving tray or the trough, and the collected water level signal is transmitted to the data processing center, thereby judging the water leakage situation of the system.

The temperature sensor is arranged at a connection terminal inside the power distribution box and detects a temperature signal in the power distribution box, and the collected temperature information is transmitted to the data processing center, thereby judging whether the connection terminal in the power distribution box has a phenomenon of excessively high temperature or not.

The device temperature sensor has a device environment temperature collection function, and transmits the collected device environment temperature information to the data processing center, thereby judging whether the current device environment temperature is lower than zero or not; and when the environment temperature is lower than zero, the data processing center controls the water pump to be automatically started. The icing of the water in the system pipeline is prevented from frost cracking a water pipe.

The present invention has a function for collecting the device micro vibration displacement signal, and pre judges an occurrence time of the fault through the data processing center, thereby issuing an alarm and requiring the timely processing.

The present invention has a function for collecting the device motor temperature, current and voltage signals, and pre-judges an occurrence time of the fault through the data processing center, thereby issuing an alarm and requiring the timely processing.

The present invention has a function for collecting the dissolved oxygen content, turbidity, PH value and electric conductivity signals of the system water, thereby pre judging an automatic starting and stopping time of the vacuum oxygen removal apparatus and the water treatment apparatus.

The present invention has a function for collecting information parameters such as device operation time, operation conditions, temperature, pressure, natural gas leakage and the like, uploads the collected information to the data processing center or a remote processing center, and pre-judges an occurrence time of the fault, thereby issuing an alarm and requiring the personnel to process the fault on site in time,

The present invention has a function for collecting water level information and uploads the detected water level and water volume information to the data processing center, thereby issuing an alarm and requiring the personnel to process the fault on site in real time. A sudden system accident is prevented from causing the loss of the system water and from causing the loss.

The present invention has a function for collecting temperature of the power distribution box, uploads the collected information to the data processing center, and pre-judges a fault according to the temperature, thereby issuing an alarm and requiring the personnel to process the fault on site in real time. The excessively high temperature is prevented from shortening the service life of the electrical device in the power distribution box and causing a danger, cm I claim:

1. An intelligent online fault detection and early warning method for a heating and ventilation machine room, characterized in that: a data processing center and a data collection center are established in the heating and ventilation machine room, and various signal collection units are respectively arranged in each device part of a pipeline system and an electrical system of the heating and ventilation machine room; with regard to the pipeline system, the signal collection units collect an operation time signal and a micro vibration displacement signal of device parts in the pipeline system as well as a temperature signal, a pressure signal, a water quality signal and a water level signal of water in the device parts; with regard to the electrical system, the signal collection units collect a voltage signal, a current signal and a temperature signal of the device parts in the electrical system; and
the data collection center collects signals collected by the signal collection units in various device parts and transmits the signals to the data processing center; the data processing center processes the signals collected by various signal collection units through a program, judges an operation condition of each device part according to the signals, and predicts a future operation condition of each device part; when the data processing center judges that the device parts have a fault or predicts that the device parts would have a fault in the future, a warning signal is sent out; meanwhile, the data processing center controls an execution part in a corresponding device part to act, sends out an online and remote warning signal for a problem that cannot be, processed and restored by the corresponding device part or system so as to prompt the working personnel to perform corresponding processing, and has a function for automatically protecting a system, which is not processed arid restored in time or would have a major fault, against starting up.

2. The intelligent online fault detection and early warning method for the heating and ventilation machine room according to claim 1, characterized in that: a signal collection unit for collecting an overall environment signal is also arranged in the heating and ventilation machine room, wherein the environment signal collected by the signal collection unit includes but not limited to an overall temperature signal and a harmful gas signal of the heating and ventilation machine room; and the data processing center controls an execution part in the corresponding device part to act according to the collected signal, or transmits a remote online and remote warning signal for the problem that cannot be automatically processed and restored by the system so as to prompt the working personnel to perform corresponding maintenance and processing, and has a function for automatically protecting a system, which is not processed and restored in time or would have a major fault, against starting up.

3. The intelligent online fault detection and early warning method for the heating and ventilation machine room according to claim 1, characterized in that: a water quality signal includes but not limited to a turbidity signal, a PH value signal, a dissolved oxygen content signal and an electric conductivity signal; and the data processing center controls an execution part in the corresponding device part to act according to the collected signal, or transmits an online and remote warning signal for the problem that cannot be automatically processed and restored by the system so as to prompt the working personnel to perform corresponding processing, and has a function for automatically protecting a system, which is not processed and restored in time or would have a major fault, against starting up.

4. The intelligent online fault detection and early warning method for the heating and ventilation machine room according to claim 1, characterized in that: signals comprise but not limited to a device operation time signal and a micro vibration displacement signal, and the data processing center judges whether the device parts in the pipeline system reach a maintenance phase or not according to the collected signal, and prompts the working personnel to perform the maintenance on site, or judges a probable running vibration major accident situation of the device parts in the pipeline system according to the collected signal, transmits an online and remote warning signal so as to prompt the working personnel to perform corresponding processing, and has a function for automatically protecting a system, which is not processed and restored in time or would have a major fault, against starting up,

5. The intelligent online fault detection and early warning method for the heating and ventilation machine room according to claim 1, characterized in that: an online and remote way is a wireless transmission mode of an Internet or cell phone terminal.

6. The intelligent online fault detection and early warning method for the heating and ventilation machine room according to claim 1 characterized in that: the data, processing center is configured to transmit a result after being processed by a remote Internet data processing center or a machine room data processing center.
